(19) United States
(12) Patent Application Publication
(10) Pub. No.: US 2013/0061607 A1
(43) Pub. Date: Mar. 14, 2013

(54) COOLING SYSTEM

(71) Applicant: Andres KUNDIG, Uerikon (CH)

(72) Inventor: Andres KUNDIG, Uerikon (CH)

(73) Assignee: LINDE AKTIENGESELLSCHAFT, Munchen (DE)

(21) Appl. No.: 13/606,920

(22) Filed: Sep. 7, 2012

(30) Foreign Application Priority Data
Sep. 8, 2011 (DE) 10 2011 112 911.5

(51) Int. Cl. F25B 45/00; F17C 3/08

(52) U.S. Cl. 62/45.1; 62/292; 62/77

(57) ABSTRACT

The invention relates to a cooling system for cooling a refrigeration consumer (K) that has a single-stage or multi-stage compressor to compress refrigerant circulating in the cooling system, at least one heat exchanger to cool the refrigerant, and at least one expansion turbine to expand the refrigerant in a way that gives off cold. A storage device that serves to store liquid refrigerant is assigned to the cooling system, or a storage device is integrated into the cooling system, in such a way that at least temporarily, liquid refrigerant can be fed into the cooling circuit from the storage device.

### SUMMARY OF THE INVENTION

The invention refers to a cooling system for providing refrigeration to a facility in need thereof (hereinafter, refrigeration consumer), comprising:
a single-stage or multi-stage compressor that serves to compress refrigerant circulating in the cooling system,
at least one heat exchanger that is used to cool the refrigerant, and
at least one expansion turbine that is used for expanding the refrigerant, giving off cold.

In addition, the invention relates to a process for operating a cooling system.

Generic cooling systems are fairly well known from the state of the art; DE 102007005098 is mentioned just by way of example. In generic cooling systems, an isothermal cooling capacity is created by means of evaporating a single-component or multi-component refrigerant, for example helium. To do this, the refrigerant is expanded in one or more expansion turbines.

Particularly in generic cooling systems in which helium is used as the refrigerant, load variations that arise are compensated by electrical heaters. The cooling systems themselves are operated at their maximum capacity. The load of generic cooling systems, particularly of helium cooling systems in the temperature range of under 5 K, can be increased only comparatively slowly. Even when the expansion turbines can be started up quickly, their capacity becomes available only a little at a time for the production of cold. A required increase in performance of a cooling system necessitates that the temperatures in the heat exchangers be reduced. This reduction temporarily consumes a significant portion of the available turbine output.

In the case of too rapid an increase in load, the temperature in the cooling circuit of the refrigeration consumer (e.g., superconducting magnets, cavities and cold neutron sources) may be raised, and the production of fluid within the cooling circuit of the cooling system may be interrupted. This leads, however, to an undesirable and even unstable condition of the cooling system. The sudden removal of load is, however, less problematic. Usually, the dropped load can be offset in this case by liquefaction of a refrigerant. This refrigerant can be part of the refrigerant inventory of the cooling system, or it can be added as a gas at ambient temperature.

An aspect of this invention is to provide a generic cooling system, as well as a generic process for operating a cooling system, which avoids the above-mentioned disadvantages, and in particular enables reliable and economical operation of the cooling system in the event that (short-term) load variations arise.

Upon further study of the specification and appended claims, other aspects and advantages of the invention will become apparent.

To achieve these aspects, a generic cooling system is proposed that is characterized in that a storage device, that serves to store liquid refrigerant, is assigned to the cooling system, or a storage device is integrated into the cooling system, in such a way that, at least temporarily, liquid refrigerant can be fed from said storage device into the refrigeration circuit.

The process according to the invention for operating a cooling system is characterized by the fact that, when an established cool load value is exceeded, feeding of liquid refrigerant from the storage device occurs.

According to the invention, in the event of a rapid increase in the heat load, the cooling circuit of the cooling system will now be supported with liquid refrigerant from the storage device, which is preferably a Dewar. This liquid refrigerant immediately supplements the cooling system's stream of liquid produced at this time. In addition, the cold from the refrigerant vapor that arises can be used to rapidly condition the heat exchangers of the cooling system. The evaporated and heated refrigerant is preferably re-liquefied at a later time, under steady-state operating conditions and under a lower heat load.

The process according to the invention for operating a cooling system further provides that, while liquid refrigerant is being supplied, the or at least one of the expansion turbines can be throttled or shut down and the compressor flow that is thereby freed up be additionally liquefied.

According to the above-mentioned advantageous configuration of the process of the invention for operating a cooling system, preferably enough liquid refrigerant is supplied that, due to the cooling capacity of the refrigerant that is to be additionally heated, individual expansion turbines of the cooling system that expand not via refrigeration consumers, but rather directly into low pressure—in the case of the embodiment presented in FIG. 1, this is the expansion turbine X —can be throttled or shut down.

Preferably, the expander or expansion turbine with the highest operating temperature is throttled or shut down first, and then that with the second highest operating temperature, etc. The compressor flow that is thus freed up can be liquefied as an additional flow and fed to the refrigeration consumer. In a restricted time window, a refrigerating capacity can be created by means of this procedure that exceeds the long-term refrigerating capacity of the cooling system by up to about 100%.

In the case of the cooling system according to the invention, as well as the process according to the invention for operating a cooling circuit, the refrigerating capacity can be used not only as an isothermal evaporation capacity, but also as a heating single-phase refrigerant flow.

In addition, one or more cold circulation pumps can be used to enhance the single-phase refrigerant flow.

### BRIEF DESCRIPTION OF THE DRAWINGS

The cooling system according to the invention, the process according to the invention for operating a refrigeration circuit, and additional advantageous configurations of the same are explained in greater detail below in conjunction with the accompanying drawing wherein:

FIG. 1 illustrates an embodiment of the invention.

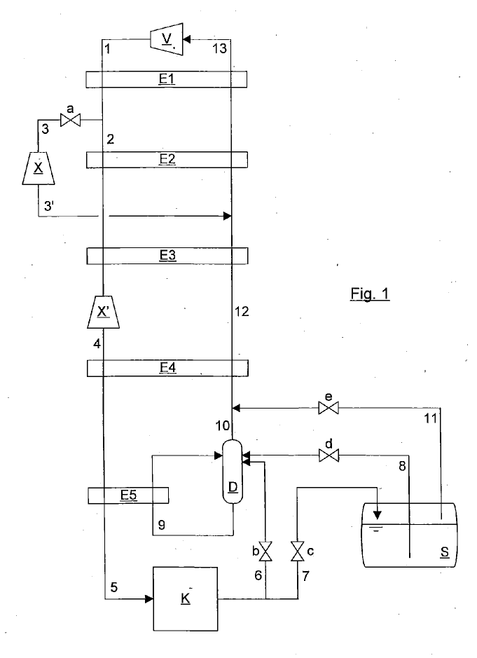

The cooling system that is depicted in FIG. 1 and that serves to supply cold for a refrigeration consumer K has five heat exchangers E1 to E5, a single-stage or multi-stage compressor unit V, two expansion turbines X and X′, a separator D, a Dewar S, five expansion valves a to e, and connecting pipes 1 to 13 that connect the above-mentioned components. It should be emphasized that the concept according to the invention is also applicable to other arrangements of compressor unit(s) and expansion turbine(s).

The refrigerant, which is compressed in the compressor unit V to the maximum circuit pressure, is guided via line 1 through the heat exchanger E1 and is cooled therein against itself. While the main flow of the refrigerant is guided via line 2 through the heat exchangers E2 and E3 and is cooled against itself, a partial flow of the refrigerant is fed via line 3 to a first expansion turbine X and is expanded therein, giving off cold. The expanded partial flow of refrigerant is subsequently fed via line 3′ to the refrigerant flow 12 that is to be heated, which will be discussed in further detail below.

The above-mentioned main flow of the refrigerant 2 is expanded in a second expansion turbine X′, giving off cold, and is subsequently guided via line 4 through heat exchangers E4 and E5 and is cooled against itself therein to the lowest desired circuit temperature. After passing through the heat exchanger E5, this refrigerant flow is fed via line 5 to a refrigeration consumer K, which is depicted in schematized form. A defined heat input to the refrigerant occurs in the refrigeration consumer K, thus resulting in a substantial increase in the refrigerant temperature.

During the start-up procedure of the refrigeration circuit, the refrigerant drawn off from the refrigeration consumer K is fed via the line 6 to a separator D. The liquid portion of the refrigerant that accumulates in the bottom thereof is drawn off via line 9 from the separator D, fed in counter-current to the refrigerant 4 to be cooled via line 9 through the heat exchanger E5, and subsequently released again to the separator D.

Gaseous refrigerant is drawn off at the head of the separator D via line 10, is fed to the heat exchanger E4, and is heated therein against the refrigerant flow 4 that is to be cooled. This refrigerant flow is subsequently guided through the heat exchangers E3, E2, and E1 via line 12 and in this case is heated in counter-current to the refrigerant flow 1/2 that is to be cooled. The refrigerant that is heated in this way is drawn off from the heat exchanger E1 via line 13 and is once again fed to the compressor unit V.

During normal operation, the refrigerant that is heated in the refrigeration consumer K is fed via the line 7 to a storage device; said storage device is, as depicted in FIG. 1, preferably designed in the form of a Dewar S. Gaseous refrigerant is drawn off from the gas compartment of the Dewar S via line 11 and is fed directly to the heat exchanger E4.

If an increase in the heat load in the refrigeration consumer K now occurs, liquid refrigerant is fed via line 8 from the Dewar S into the refrigeration circuit via the separator D. This feeding-in of liquid refrigerant 8 preferably occurs only when a specified cold-load value in the refrigeration consumer K is exceeded.

The control valves a to e that are depicted in the FIGURE serve to adjust the mass flows of refrigerant in the assigned lines 3, 6, 7, 8, and 11. By means of the control valve a, the expansion turbine X can be throttled, which has the effect that the compressor flow or refrigerant stream thus freed up can also be liquefied. The control valve d, which determines the mass flow of the liquid refrigerant that is supplied from the Dewar, is preferably regulated via the fluid level within the separator D. When the liquid level drops below an adjustable value, the control valve d opens and thereby allows liquid refrigerant to be fed in via line 8 from the Dewar S. While the control valve e is usually controlled by means of a differential pressure measurement, the control valves b and c are preferably regulated via the pressure of the refrigerant directly upstream from the refrigeration consumer K.

The cooling system according to the invention and the process according to the invention for operating a cooling system make it possible to react rapidly and reliably to short-term load variations. The necessary extra expense, in the form of a storage device and the corresponding control valves, is manageable and is offset by the advantages gained.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

The entire disclosures of all applications, patents and publications, cited herein and of corresponding German application No. 10 2011 112 911.5, filed Sep. 8, 2011, are incorporated by reference herein.

1. A cooling system for providing refrigeration to a facility in need thereof, said cooling system comprising:
a cooling circuit for circulating refrigerant,
a single-stage or multi-stage compressor (V), which serves to compress refrigerant circulating in said cooling circuit of said cooling system,
at least one heat exchanger (E1, E2), which serves to cool the refrigerant circulating in said cooling circuit,
at least one expansion turbine (X, X′), which serves to expand the refrigerant circulating in said cooling circuit in a way that provides cold, and
a storage device, that serves to store liquid refrigerant, wherein at least temporarily, liquid refrigerant (8) can be fed from said storage unit into said cooling circuit.

2. The cooling system according to claim 1, wherein said storage device is a Dewar (S).

3. The cooling system according to claim 1, wherein said refrigerant is helium.

4. The cooling system according to claim 2, wherein said refrigerant is helium.

5. A process for operating a cooling system according to claim 1, comprising:
circulating said refrigerant in said cooling circuit; and
when a specified cold-load value is exceeded, feeding liquid refrigerant (8) from said storage device into said cooling circuit.

6. The process according to claim 5, wherein, while liquid refrigerant (8) is being fed into said cooling circuit, at least one expansion turbine (X, X′) is throttled or shut down and the compressor flow from said single-stage or multi-stage compressor (V) that is thus freed up is additionally liquefied.
